(19) United States
(12) Patent Application Publication
(10) Pub. No.: US 2024/0101395 A1
(43) Pub. Date: Mar. 28, 2024

(54) BOTTOM DOOR MONITORING SYSTEM AND METHODS OF USE THEREOF

(71) Applicant: Electronic Controls Inc., Cape Canaveral, FL (US)

(72) Inventors: Walter Heidt Barnes, Merritt Island, FL (US); Michael Rose, Orange City, FL (US); Frank Gozukizil, San Diego, CA (US)

(73) Assignee: Electronic Controls Inc., Cape Canaveral, FL (US)

(21) Appl. No.: 18/371,498

(22) Filed: Sep. 22, 2023

Related U.S. Application Data
(60) Provisional application No. 63/409,380, filed on Sep. 23, 2022.

(51) Int. Cl. B66B 13/22; B66B 1/34; G01K 3/00; G01V 8/14

(52) U.S. Cl. CPC B66B 13/22; B66B 1/3461; G01K 3/005; G01V 8/14

(57) ABSTRACT

Systems and methods for monitoring the bottom of the doors to an elevator to increase safety in and around the elevator cab and prevent dangerous conditions when a hallway or cab door to the elevator is damaged, loose, misaligned, or malfunctioning.

### CROSS-REFERENCE TO RELATED APPLICATIONS

This application claims priority to U.S. Provisional Patent Application No. 63/409,380, filed Sep. 23, 2022, the specification, drawings, and appendices thereof are incorporated herein by reference in their entirety.

### FIELD OF INVENTION

The present disclosure relates generally to elevator electronics and, in particular, methods and systems for monitoring the bottom of the doors to an elevator. Uses for the monitoring system of the present disclosure may include, but are not limited to, increasing safety in and around the elevator cab. For example, the monitoring system of the present disclosure may help to prevent dangerous conditions due to operation of, ingress to, egress from, or motion of an elevator cab when a door to the elevator is damaged, loose, misaligned, or malfunctioning.

### BACKGROUND OF THE INVENTION

An elevator cab is a vehicle for vertical motion within an elevator shaft (or hoistway) from the hallway of one floor of a building to the hallway of another floor of the building. Many elevator cabs have at least one set of cab doors, which move vertically with the elevator cab. Some elevator cabs have multiple sets of cab doors that move vertically with the elevator cab. In many environments of an elevator cab, there are hallway doors to the hallway of each floor of a building. Such hallway doors are fixed in position and do not move vertically with the elevator cab. The hallway doors then open in tandem with the cab doors when the elevator cab is being entered or exited at the floor of the hallway doors.

The bottom of cab doors is attached proximate the bottom of the elevator cab. Similarly, the bottom of hallway doors is attached proximate the floor of the hallway. When the bottom attachment becomes damaged, broken, loose, weak, or misaligned, a potential threat is posed to people nearby or using the elevator because cab doors (and hallway doors) are intended to prevent people and objects from falling out of the cab (or hallway) into the hoistway. These doors also should prevent people and objects from becoming stuck between the elevator cab and the inside of the hoistway or the floor of the hallway. However, if a bottom attachment becomes damaged, broken, loose, weak, or misaligned, then a person or object could potentially fall into the hoistway or become stuck between the elevator cab and the inside of the hoistway or the floor of the hallway.

In addition, if the doors are not fit and positioned as designed, then damage to the elevator cab, to the hoistway (or equipment in the hoistway), or to the building could occur when the elevator cab moves in the hoist way. For example, a cab door that juts out from the elevator cab could catch on equipment or on the inside of the hoistway and cause damage. In addition, a hallway door that juts out from the hallway into the hoistway could catch on a moving elevator cab and cause damage.

Thus, a need exists to monitor the bottom connection and the position and attitude of cab doors and of hallway doors. Moreover, a need exists to detect bottom connections that are damaged, broken, loose, weak, or misaligned. Therefore, it would be advantageous to develop systems and methods to monitor bottom connections or detect such precarious situations (or both). In this aspect, a need exists for such systems and methods to be applicable both to new elevator installations and to existing elevator structures (for example, as a retrofit).

The present disclosure describes such systems and methods. In particular, the present disclosure describes systems that monitor the distance or alignment between a cab door and the bottom of the elevator cab, systems that monitor the distance or alignment between a hallway door and the floor of the hallway, systems that detect problematic changes to such distance or alignment, systems that provide an alert of bottom connections that are damaged, broken, loose, weak, or misaligned, and methods of use for such systems.

### SUMMARY OF THE INVENTION

A bottom door monitoring system of the present disclosure provides continuous monitoring of hoistway door dislodge. The present disclosure relates to an elevator door monitoring system including:
a main board of an elevator system operatively coupled to and powered by a power source, wherein the main board is also operatively coupled to a safety circuit;
at least one sensor board operatively coupled to a main board and having at least one sensor mount;
a laser capable of producing a laser beam;
a sensor capable of detecting the laser beam, wherein the laser and sensor are each operatively connected to the at least one sensor mount;
a reflector optically coupled to the laser and the sensor such that when the sensor stops detecting the laser beam, the sensor board relays a NOT SENSING signal to the main board and the main board sends a STOP SIGNAL to the safety circuit.

In some embodiments, the at least one sensor board and main board are operatively connected by a Category 5 twisted pair cable. In other embodiments, the at least one sensor board has a plurality of sensor mounts operatively connected thereto. In still other embodiments, the laser beam is a frequency-modulated laser beam, an amplitude modulated laser beam, a continuous-wave laser beam, or a pulsed laser beam. In yet other embodiments, the sensor is capable of detecting an amplitude of the laser beam. In various embodiments, the reflector may be positioned on a bottom edge of a hallway-door of an elevator system. In other embodiments, the reflector is positioned on a bottom edge of a cab door of an elevator system. In still other embodiments, the at least one sensor board further includes a temperature sensor.

The present disclosure also relates to an elevator door monitoring system for use with an elevator system having a plurality of landings:
a main board of an elevator system operatively coupled to and powered by a power source;
a plurality of sensor boards each operatively coupled to the main board and each having at least one sensor mount operatively coupled to (i) a laser capable of producing a laser beam and (ii) a sensor capable of detecting the laser beam; and
a plurality of reflectors, wherein each reflector is attached to a bottom edge of a hallway-door at each landing, wherein each reflector is capable of reflecting the laser beam to the sensor, and wherein each reflector is oriented with respect to the laser and sensor such that when the sensor does not detect the laser beam, the sensor board relays a NOT SENSING signal to the main board.

In some embodiments, each sensor board further includes a temperature sensor. In other embodiments, the main board is operatively coupled to a safety circuit of the elevator system. In still other embodiments, the main board receives the NOT SENSING signal, the main board sends a STOP SIGNAL to the safety circuit. In yet other embodiments, each sensor board and main board are operatively coupled by a Category 5 twisted pair cable. In various embodiments, each sensor board has a plurality of sensor mounts operatively connected thereto. In some embodiments, the laser beam is a frequency-modulated laser beam, an amplitude modulated laser beam, a continuous-wave laser beam, or a pulsed laser beam. In other embodiments, the sensor is capable of detecting an amplitude of the laser beam.

The present disclosure further relates to an elevator door monitoring system including:
a main board of an elevator system operatively coupled to and powered by a power source, wherein the main board is also operatively coupled to a safety circuit;
a plurality of sensor boards each operatively coupled to the main board and each having at least one sensor mount operatively coupled to (i) a laser capable of producing a laser beam and (ii) a sensor capable of detecting the laser beam, wherein each sensor board is positioned at a different landing in the elevator system; and
a plurality of reflectors optically coupled to the laser and the sensor of each sensor board, wherein each reflector is attached to a bottom edge of a hallway-door at each landing, and wherein the sensor board relays a NOT SENSING signal to the main board when the sensor is unable to detect the laser beam and the main board then sends a STOP SIGNAL to the safety circuit.

In some embodiments, the sensor is capable of detecting an amplitude of the laser beam. In other embodiments, the laser beam is a frequency-modulated laser beam, an amplitude modulated laser beam, a continuous-wave laser beam, or a pulsed laser beam. In yet other embodiments, each sensor board further includes a temperature sensor.

### BRIEF DESCRIPTION OF THE DRAWINGS

The following drawings are attached to—and form a portion of—this disclosure. Implementation of the monitoring system and methods of use thereof are described, by way of example only, with reference to the following figures:

FIG. 1 is a view of an elevator system;

FIG. 2 is a front view of a cab;

FIG. 3 is a partial side view of an elevator system;

FIG. 4 is a schematic view of a bottom door monitoring system in accordance with an embodiment of the present disclosure;

FIG. 5 is a partial side view of a bottom door monitoring system and an elevator system in accordance with an embodiment of the present disclosure; and

FIG. 6 is a partial side view of a bottom door monitoring system and an elevator system after a dislodgment in accordance with an embodiment of the present disclosure.

### DETAILED DESCRIPTION OF THE INVENTION

As described in more detail below, the present disclosure relates to bottom door monitoring systems and methods for using such monitoring systems developed by the inventors. While embodiments of the bottom door monitoring system and methods for using such monitoring system for use with elevators are generally discussed and illustrated, variations could be advantageously used in many types of environments or vehicles. In other words, the teachings of this disclosure may be advantageous in other classes of transport, including other modes of cable transportation and modes of rail transportation.

### Definitions

Unless otherwise defined, all terms (including technical and scientific terms) in this disclosure have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly defined otherwise in this disclosure. For brevity or clarity, well known functions or constructions may not be described in detail.

The terms “about” and “approximately” shall generally mean an acceptable degree of error or variation for the quantity measured in light of the nature or precision of the measurements. Numerical quantities given in this description are approximate unless stated otherwise, meaning that the term “about” or “approximately” can be inferred when not expressly stated.

The terminology used throughout the disclosure is for the purpose of describing particular embodiments only and is not intended to be limiting. The singular forms “a,” “an,” and “the” are intended to include the plural forms as well, unless the context clearly indicates otherwise.

The terms “first,” “second,” and the like are used to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the disclosure. Likewise, terms like “top” and “bottom,” “front” and “back,” and “left” and “right” are used to distinguish certain features or elements from each other, but it is expressly contemplated that a top could be a bottom, and vice versa.

The terms “connected to,” “in connection with,” “in communication with,” or “connecting” one or more other parts refer to any suitable connection or communication, including mechanical connection, electrical connection (e.g., one or more wires), or signal-conducting channel (e.g., Bluetooth®, Near-Field Communication (NFC), or other inductive coupling or radio-frequency (RF) link).

The term “processor” may include one or more processors having processing capability necessary to perform the processing functions described herein, including but not limited to hardware logic, computer readable instructions running on a processor, or any suitable combination thereof. A processor may run software to perform the operations described herein, including software accessed in machine readable form on a tangible non-transitory computer readable storage medium, as well as software that describes the configuration of hardware such as hardware description language (HDL) software used for designing chips.

The term “memory” may refer to a tangible or non-transitory storage medium. Examples of tangible (or non-transitory) storage media include disks, thumb drives, and memory, etc., but do not include propagated signals. Tangible computer readable storage media include volatile and non-volatile, removable and non-removable media, such as computer readable instructions, data structures, program modules, or other data. Examples of such media include RAM, ROM, EPROM, EEPROM, SRAM, flash memory, disks or optical storage, magnetic storage, or any other non-transitory medium that stores information that is accessed by a processor or computing device.

It is to be understood that any given elements of the disclosed embodiments of the invention may be embodied in a single structure, a single step, or the like. Similarly, a given element of the disclosed embodiment may be embodied in multiple structures, steps, or the like.

### Monitoring System

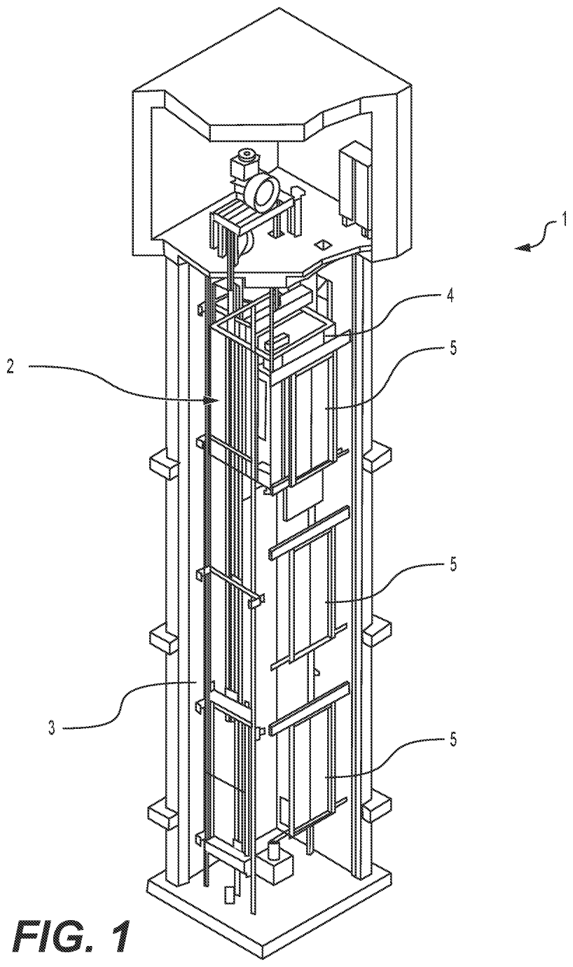

As shown in FIG. 1, an elevator system 1 has a cab 2 (or “car”) in a hoistway 3 (or “shaft”). The cab 2 has one or more cab doors 4. For example, while most elevator cabs have only one door on the front (generally referred to as an enter/exit same-side configuration), some elevator systems will have a second entry point on the opposite side requiring a second cab door. The present disclosure contemplates use of the monitoring systems for both types of cabs. The elevator system also has hallway doors 5 located at each story of the building in which the elevator system 1 is installed. Again, elevator systems may have one of more entry points and, as such, some elevator systems will have a second entry point on the opposite side requiring a second set of hallway doors.

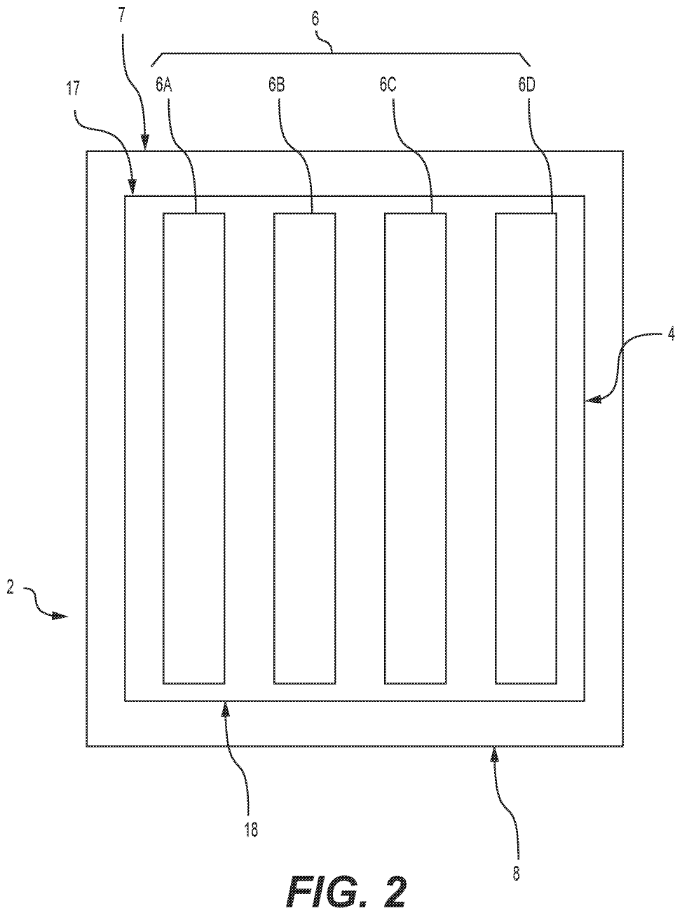

FIG. 2 is a front view of a cab 2. As discussed above, the cab 2 has one or more cab doors 4 that has panels 6 thereon. In the embodiments shown in FIG. 2, the cab door 4 has four panels 6A, 6B, 6C, 6D. In other embodiments, the cab door 4 might have a different number of panels 6—in one embodiment, the cab door 4 has at least five panels. In another embodiment, the cab door 4 has at least six panels. In still another embodiment, the cab door has between one and eight panels. The cab 2 has a top-front edge 7 and a bottom-front edge 8. Each cab door 4 has a cab-door top edge 17 and a cab-door bottom edge 18.

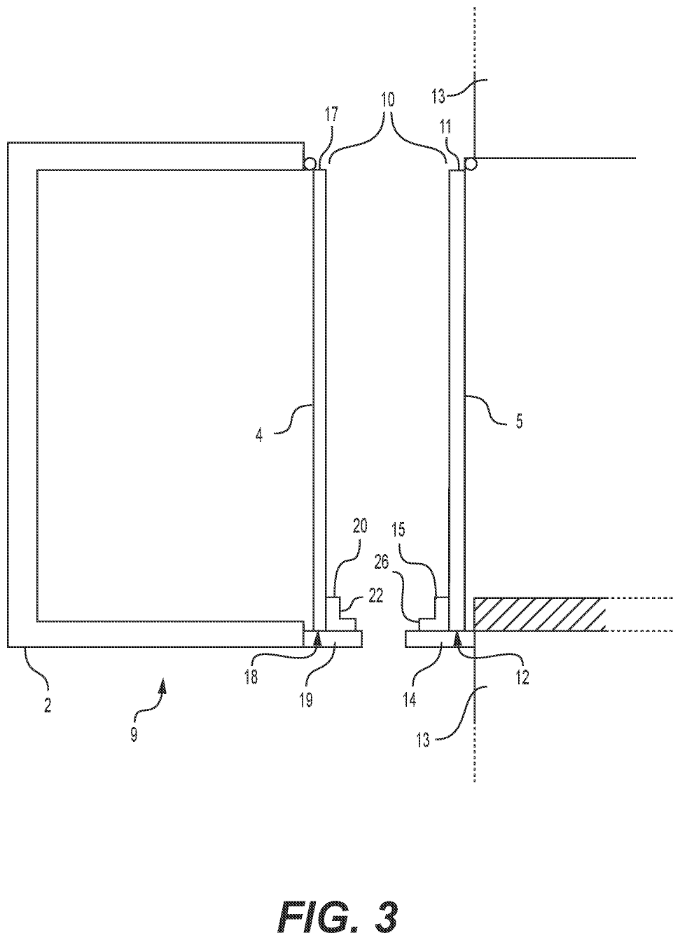

FIG. 3 is a partial side view of an elevator system 9. Each cab door 4 is proximate and substantially parallel to each hallway door 5. Between cab door 4 and hallway door 5 is a cab-hallway gap 10. In some embodiments, the cab-hallway gap 10 is less than approximately 6 inches, for example, between approximately 2 inches and approximately 5 inches, or between approximately 3 inches and approximately 4 inches. In other embodiments, the cab-hallway gap is about 1 to about 6 inches. For example, the cab-hallway gap 10 may be about 2 to about 4 inches.

The hallway door 5 has a hallway-door top edge 11 and a hallway-door bottom edge 12. The hallway door 5 is mechanically connected to the building 13 by a suitable mechanical connection (not specifically shown in FIG. 3) at the hallway-door top edge 11.

The hallway-door bottom edge 12 slides along a hallway-door sill 14 by a suitable hallway-door carriage device 15. In one embodiment, the hallway-door carriage device 15 is a hallway-door gib 16 (not specifically shown in FIG. 3). The hallway-door gib 16 keeps the hallway-door bottom edge 12 from swinging (or being pushed) out of the hallway-door sill 14. In some embodiments, the hallway-door gib 16 is plastic or nylon. In one aspect, the hallway-door gib 16 is plastic. In another aspect, the hallway-door gib 16 is nylon. In another aspect, the hallway-door gib 16 is formed of a material including plastic and nylon. The hallway-door gib 16 is mechanically connected to the hallway-door sill 14 by any suitable fastener (not specifically shown in FIG. 3). In one embodiment, the hallway-door gib 16 is connected to the hallway-door sill 14 by one or more screw fasteners.

The cab door 4 is mechanically connected to the cab 2 by a suitable mechanical connection (not specifically shown in FIG. 3) at the cab-door top edge 17. In some embodiments, the cab-door bottom edge 18 slides along a cab-door sill 19 by a suitable cab-door carriage device 20. For example, the cab-door carriage device may be a cab-door gib 21 (not specifically shown in FIG. 3). The cab-door gib 21 keeps the cab-door bottom edge 18 from swinging (or begin pushed) out of the cab-door sill 19. In some embodiments the cab-door gib 21 is plastic or nylon. In one aspect, the cab-door gib 21 is plastic. In another aspect, the cab-door gib 21 is nylon. In another aspect, the cab-door gib 21 is formed of a material including plastic and nylon. The cab-door gib 21 is mechanically connected to the cab-door sill 19 by a suitable fastener (not specifically shown in FIG. 3). In one embodiment, the cab-door gib 21 is connected to the cab-door sill 19 by one or more screw fasteners.

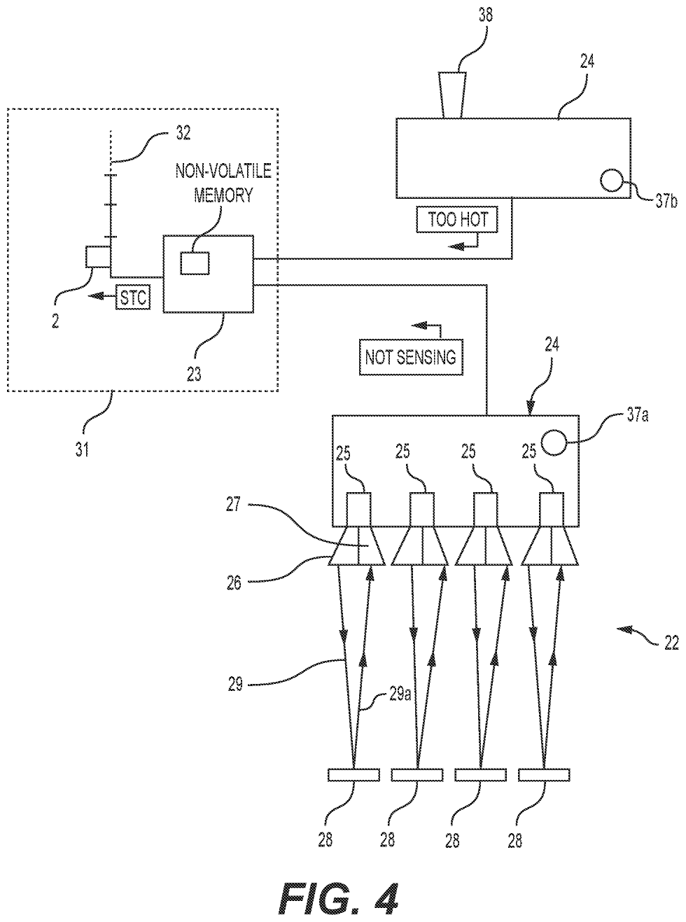

FIG. 4 is a schematic view of a bottom door monitoring system 22 according to an embodiment of the present disclosure. The bottom door monitoring system 22 has a main board 23, which is a central processing unit (“CPU”) or controller of elevator system 31, coupled with at least one sensor board 24. Communications ports facilitate data exchange between the sensor board(s) and main board. In some embodiments, the main board 23 is coupled to each sensor board 24 by a Category 5 (“Cat 5”) twisted-pair cable. The main board 23 may also be coupled to a safety circuit and/or fire service circuitry of the elevator system 31. In some embodiments, the safety circuit is safety string 32. In certain embodiments, the main board 23 is situated in the control room of the elevator, preferably near or next to the elevator controller.

Each sensor board 24 has at least one sensor mount 25. In the embodiment shown in FIG. 4, the sensor board 24 has four sensor mounts 25. In other embodiments, the sensor board 24 has other numbers of sensor mounts. For example, in one embodiment, the sensor board 24 has one sensor mount. In another embodiment, the sensor board has a plurality of sensor mounts, e.g., two sensor mounts, three sensor mounts, five sensor mounts, six sensor mounts, and the like. In some embodiments, the sensor board 24 has between about one and eight sensor mounts. In this aspect, the number of sensor mounts 25 on each sensor board 24 may be the same as the number of panels 6 (not shown in FIG. 4) on the cab door 4 (not shown in FIG. 4) of an elevator system 31 with which the bottom door monitoring system 22 is used. For instance, if there are five panels 6, there may be five sensor mounts 25 on each sensor board 24.

Each sensor mount 25 is operatively connected a laser 26 and sensor 27. The laser 26 produces a laser beam 29. Laser beam 29 may be a frequency-modulated laser beam, an amplitude modulated laser beam, a continuous-wave laser beam, or a pulsed laser beam. In some embodiments, the laser beam 29 is unique to the laser 26. For example, the modulations of laser beam 29 may be unique to the laser 26.

The bottom door monitoring system 22 has at least one reflector 28. The reflector 28 is any suitable reflector of the laser beam 29. In one embodiment, the reflector is a structured reflector such as the one described in U.S. patent application Ser. No. 18/096,689, filed Jan. 13, 2023, the entire disclosure of which is incorporated by reference herein. The reflector 28 is placed such that the laser beam 29 will fall on the reflector 28. In other words, the reflector is optically coupled to the laser 26. In some embodiments, the reflector 28 is oriented such that, when the laser beam 29 produced by the laser 26 falls on the reflector 28, the reflector 28 reflects the laser beam (shown as 29a) to the sensor 27. In this aspect, the sensor 27 is optically connected to the reflector 28 and, thus, to the laser 26. In one embodiment, the reflector 28 is placed proximate a bottom edge of the hallway door or cab door.

The reflector 28 may be attached to the hallway or cab door (as applicable) using any suitable fastener (not specifically shown). In one embodiment, the reflector is removably attached to the hallway or cab door (as applicable). In this aspect, the fastener may be double-sided tape. One non-limiting example of double sided tape is 3M™ VHB™ tape (available from 3M).

The sensor 27 is any suitable sensor of the laser beam 29. The sensor 27 detects the laser beam 29. In some embodiments, the sensor 27 is specifically tuned to sense the laser beam 29 to the exclusion of other light sources (e.g., of other lasers or of sunlight). This tuning can be accomplished by tuning the sensor 27 to sense a laser beam having the specific modulations of laser beam 29. In some embodiments, the sensor 27 detects an amplitude of the laser beam 29.

While the sensor 27 senses the laser beam 29, the elevator system 31 allows the cab 2 to move in the normal course of operations. If the sensor 27 stops sensing the laser beam 29—or if the sensed amplitude of the laser beam 29 falls below a pre-determined threshold (e.g., 90%, 75%, 50%, or 25%)—then the sensor board 24 relays a NOT SENSING signal to the main board 23. In this aspect, the pre-determined threshold may be any threshold deemed sufficient to provide notice of and/or address a potential safety issue. In one embodiment, the threshold is between about 25 percent and about 95 percent. In another embodiment, the threshold ranges from 40 percent to about 75 percent. In still another embodiment, the threshold ranges from about 50 percent to about 90 percent. In yet another embodiment, the threshold is between about 75 percent and about 90 percent.

When the sensor board 24 relays a NOT SENSING signal to the main board 23, the main board 23 sends a STOP signal to the safety string 32, which effectively halts movement of the cab 2. In other words, depending on the system settings, a NOT SENSING signal may be sent to the elevator controller to take the elevator out of service until repairs can be made or the safety string can be reset. In some embodiments, the main board 23 stores its receipt of the NOT SENSING signal in non-volatile memory so that the state of the safety string 32 cannot be reset merely by cycling power of the elevator system 31. In some embodiments, the sensor board 24 has a reset button 37a that allows a technician to reset the state of the safety string 32 after the main board 23 receives the NOT SENSING signal.

In some embodiments, the main board may be coupled to and controls an indicator (not shown). The indicator may be a visual indicator, an audio indicator, or both (or any combination of multiples of either or both). In this aspect, a visual indicator may be any suitable visual indicator including, but not limited to, a steady light, a flashing light, a strobe light, a lighted sign, a spotlight, an annunciator panel, an LED strip, or any combination thereof. The audio indicator may be any suitable audio indicator including, but not limited to a speaker, an annunciator (e.g., a voice annunciator), a horn, a klaxon, a buzzer, a bell, a whistle, or a siren. In some aspects, the audio indicator is a voice annunciator configured to deliver a message to a user (which message the voice annunciator might be configured to repeat at regular intervals). The message may be any suitable message. In addition, the message may be in any suitable language or code. One nonlimiting example of such a message is “Warning: dislodgment event.” The indicator may be positioned in any suitable location including in the control room with the main board, within the cab, within a hallway or foyer in the building, or any combination thereof.

In some embodiments, the sensor board 24 has a temperature sensor 38. In some embodiments, when the temperature sensor 38 detects air temperature above a pre-defined threshold (e.g. 90° F. or 100° F.), then the sensor board 24 sends a TOO HOT signal to the main board 23. The pre-defined threshold may be any threshold deemed sufficient to provide notice of and/or address air temperature of concern. Once the sensor board 24 sends the TOO HOT signal to the main board 23, the main board 23 sends a STOP signal to the safety string 32, which effectively stops the movement of the cab 2. In other words, depending on the system settings, a TOO HOT signal may be sent to the elevator controller to take the elevator out of service until the issue is addressed, repairs can be made, or the safety string can be reset. In some embodiments, the main board 23 stores its receipt of the TOO HOT signal in non-volatile memory so that the state of the safety string 32 cannot be reset merely by cycling power of the elevator system 31. In yet other embodiments, the TOO HOT signal may be sent to the elevator fire service circuitry. In still other embodiments, the sensor board 24 has a reset button 37b that allows a technician to reset the state of the safety string 32 after the main board 23 receives the TOO HOT signal.

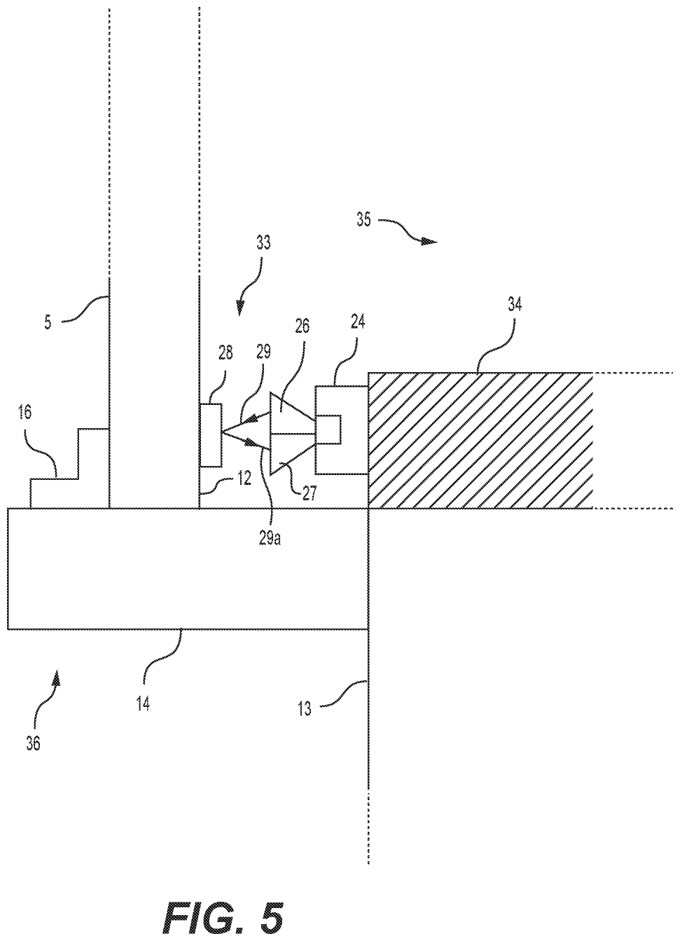

FIG. 5 is a side view of a bottom door monitoring system 33 and an elevator system 36 according to an embodiment of the present disclosure. In this embodiment, the sensor board 24 is positioned on the floor 34 of the hallway 35. The reflector 28 is positioned on the hallway-door bottom edge 12. The laser 26, reflector 28, and sensor 27 are positioned and oriented such that the laser 26 produces the laser beam 29 that is reflected by the reflector 28 (indicated as 29a) onto the sensor 27.

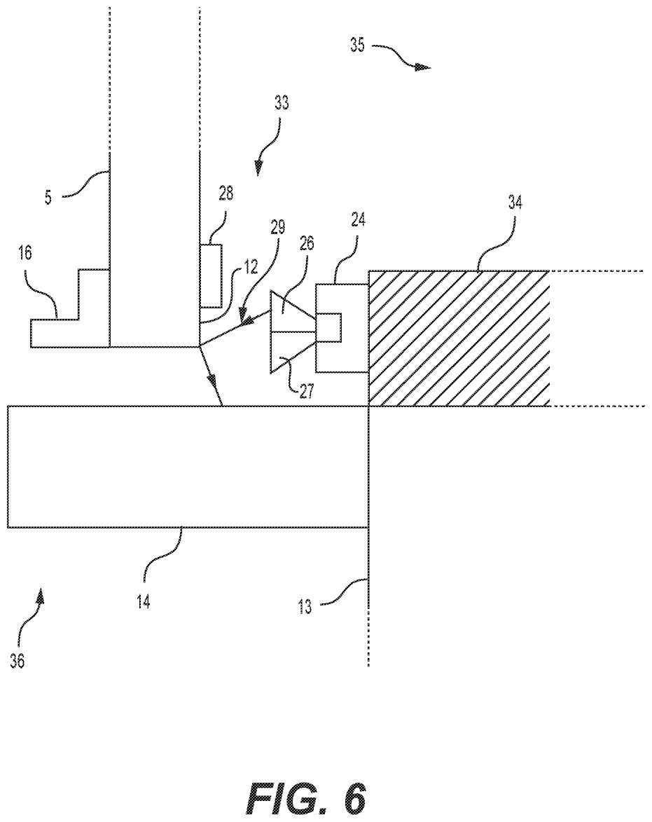

FIG. 6 illustrates a side view of a bottom door monitoring system 33 and an elevator system 36 after a dislodgment. The position and orientation of the hallway door 5 have been changed from the configuration shown in FIG. 5; thus, the relative position and orientation of the reflector 28 is different from the position and orientation of the reflector 28 in FIG. 5. As such, the sensor 27 in FIG. 6 stops sensing the laser beam 29, which then causes the sensor board 24 to relay a NOT SENSING signal to the main board 23.

FIGS. 5-6 describe the operation of a bottom door monitoring system 33 for monitoring dislodgment of a hallway door of an elevator system according to an embodiment of the present disclosure. A similar bottom door monitoring system could be installed on a cab of an elevator system (e.g., connected to the travelling system of the cab) to monitor for dislodgment of a cab door (or a panel thereof). For example, a sensor board may be positioned relative to the laser, cab reflector, and sensor such that the laser produces the laser beam that is reflected by the reflector onto the sensor to determine whether there is any dislodgment of the cab door. In particular, if the sensor in a cab bottom door monitoring system stops sensing the laser beam, it will cause the sensor board in the cab door bottom monitoring system to relay a NOT SENSING signal to the main board.

Moreover, a bottom door monitoring system in accordance with the present disclosure may be installed to monitor the hallway and/or cab doors at every landing. In this aspect, should any of the doors dislodge, or misalign at a landing, a NOT SENSING signal is relayed and stored in non-volatile memory and a signal is being sent to the elevator controller to take the elevator out of service. In this aspect, as would be understood by those of ordinary skill in the art, the cab of an elevator system stops at multiple landings (each landing having its own hallway-door(s)) and, thus, the monitoring system may be used at each landing. Similarly, an additional temperature sensor may be used at every floor to detect unusual temperatures in case of a fire or similar condition.

While the foregoing specification has described specific embodiments of this invention and many details have been put forth for the purpose of illustration or example, it will be apparent to one skilled in the art that the invention is susceptible to additional embodiments and that certain of the details described herein can be varied considerably without departing from the basic principles of the invention. Any section headings herein are provided only for consistency with the suggestions of 37 C.F.R. § 1.77 or otherwise to provide organizational cues. These headings shall not limit or characterize the invention(s) set forth herein.

What is claimed is:

1. An elevator door monitoring system comprising:
a main board of an elevator system operatively coupled to and powered by a power source, wherein the main board is also operatively coupled to a safety circuit;
at least one sensor board operatively coupled to a main board and having at least one sensor mount;
a laser capable of producing a laser beam;
a sensor capable of detecting the laser beam, wherein the laser and sensor are each operatively connected to the at least one sensor mount;
a reflector optically coupled to the laser and the sensor such that when the sensor stops detecting the laser beam, the sensor board relays a NOT SENSING signal to the main board and the main board sends a STOP SIGNAL to the safety circuit.

2. The monitoring system of claim 1, wherein at least one sensor board and main board are operatively connected by a Category 5 twisted pair cable.

3. The monitoring system of claim 1, wherein the at least one sensor board has a plurality of sensor mounts operatively connected thereto.

4. The monitoring system of claim 1, wherein the laser beam is a frequency-modulated laser beam, an amplitude modulated laser beam, a continuous-wave laser beam, or a pulsed laser beam.

5. The monitoring system of claim 1, wherein the sensor is capable of detecting an amplitude of the laser beam.

6. The monitoring system of claim 1, wherein the reflector is positioned on a bottom edge of a hallway-door of an elevator system.

7. The monitoring system of claim 1, wherein the reflector is positioned on a bottom edge of a cab door of an elevator system.

8. The monitoring system of claim 1, wherein the at least one sensor board further comprises a temperature sensor.

9. An elevator door monitoring system for use with an elevator system having a plurality of landings:
a main board of an elevator system operatively coupled to and powered by a power source;
a plurality of sensor boards each operatively coupled to the main board and each having at least one sensor mount operatively coupled to (i) a laser capable of producing a laser beam and (ii) a sensor capable of detecting the laser beam; and
a plurality of reflectors, wherein each reflector is attached to a bottom edge of a hallway-door at each landing, wherein each reflector is capable of reflecting the laser beam to the sensor, and wherein each reflector is oriented with respect to the laser and sensor such that when the sensor does not detect the laser beam, the sensor board relays a NOT SENSING signal to the main board.

10. The monitoring system of claim 9, wherein each sensor board further comprises a temperature sensor.

11. The monitoring system of claim 9, wherein the main board is operatively coupled to a safety circuit of the elevator system.

12. The monitoring system of claim 11, wherein, when the main board receives the NOT SENSING signal, the main board sends a STOP SIGNAL to the safety circuit.

13. The monitoring system of claim 9, wherein each sensor board and main board are operatively coupled by a Category 5 twisted pair cable.

14. The monitoring system of claim 9, wherein each sensor board has a plurality of sensor mounts operatively connected thereto.

15. The monitoring system of claim 9, wherein the laser beam is a frequency-modulated laser beam, an amplitude modulated laser beam, a continuous-wave laser beam, or a pulsed laser beam.

16. The monitoring system of claim 9, wherein the sensor is capable of detecting an amplitude of the laser beam.

17. An elevator door monitoring system comprising:
a main board of an elevator system operatively coupled to and powered by a power source, wherein the main board is also operatively coupled to a safety circuit;
a plurality of sensor boards each operatively coupled to the main board and each having at least one sensor mount operatively coupled to (i) a laser capable of producing a laser beam and (ii) a sensor capable of detecting the laser beam, wherein each sensor board is positioned at a different landing in the elevator system; and
a plurality of reflectors optically coupled to the laser and the sensor of each sensor board, wherein each reflector is attached to a bottom edge of a hallway-door at each landing, and wherein the sensor board relays a NOT SENSING signal to the main board when the sensor is unable to detect the laser beam and the main board then sends a STOP SIGNAL to the safety circuit.

18. The monitoring system of claim 17, wherein the sensor is capable of detecting an amplitude of the laser beam.

19. The monitoring system of claim 17, wherein the laser beam is a frequency-modulated laser beam, an amplitude modulated laser beam, a continuous-wave laser beam, or a pulsed laser beam.

20. The monitoring system of claim 1, wherein each sensor board further comprises a temperature sensor.
